(19) United States
(12) Patent Application Publication
(10) Pub. No.: US 2014/0216559 A1
(43) Pub. Date: Aug. 7, 2014

(54) DROPLET ACTUATOR WITH LOCAL VARIATION IN GAP HEIGHT TO ASSIST IN DROPLET SPLITTING AND MERGING OPERATIONS

(71) Applicant: ADVANCED LIQUID LOGIC, INC., RESEARCH TRIANGLE PARK, NC (US)

(72) Inventor: JENNIFER O. FOLEY, CARY, NC (US)

(73) Assignee: ADVANCED LIQUID LOGIC, INC., RESEARCH TRIANGLE PARK, NC (US)

(21) Appl. No.: 14/175,106

(22) Filed: Feb. 7, 2014

Related U.S. Application Data
(60) Provisional application No. 61/761,908, filed on Feb. 7, 2013.

(51) Int. Cl. F15D 1/00

(52) U.S. Cl. CPC F15D 1/00
USPC 137/1; 137/803

(57) ABSTRACT

The present invention is directed to droplet actuators with local variation in gap height and methods of their use to facilitate droplet splitting and merging operations. The droplet actuators have increased gap-height regions that track droplet transport paths such that droplets can be transported along the paths with reduced risk of merging with droplets on adjacent paths.

### 1 RELATED APPLICATIONS

In addition to the patent applications cited herein, each of which is incorporated herein by reference, this patent application is related to and claims priority to U.S. Provisional Patent Application No. 61/761,908, filed on Feb. 7, 2013, entitled “Droplet Actuator with Local Variation in Gap Height to Assist in Droplet Splitting and Merging Operations”; the entire disclosure of which is incorporated herein by reference.

### 2 FIELD OF THE INVENTION

The invention relates to droplet actuators with local variation in gap height to assist in droplet splitting and merging operations.

### 3 BACKGROUND

A droplet actuator typically includes one or more substrates configured to form a surface or gap for conducting droplet operations. The one or more substrates establish a droplet operations surface or gap for conducting droplet operations and may also include electrodes arranged to conduct the droplet operations. The droplet operations substrate or the gap between the substrates may be coated or filled with a filler fluid that is immiscible with the liquid that forms the droplets. In droplet actuators, sometimes is can be difficult to split droplets and sometimes droplets merge before intended. Therefore, there is a need for new approaches to performing droplet split and merge operations in a droplet actuator.

### 4 BRIEF DESCRIPTION OF THE INVENTION

The invention is directed to droplet actuators with local variation in gap height and methods of their use to facilitate droplet splitting and merging operations. The droplet actuators have increased gap-height regions that track droplet transport paths such that droplets can be transported along the paths with reduced risk of merging with droplets on adjacent paths.

In one embodiment, the invention provides a droplet actuator that includes a bottom substrate and a top substrate, wherein the bottom substrate and the top substrate are separated by a droplet operations gap including a droplet, in which the droplet operations gap includes local variation in gap height configured to assist in droplet splitting and/or droplet merging operations. The top substrate and/or the bottom substrate may include a droplet transport region and a droplet merge region and/or a droplet splitting region. The top substrate and/or the bottom substrate may also include one or more droplet transport paths. The local variation in gap height may include a plurality of increased gap-height regions along the one or more droplet transport paths. The plurality of increased gap-height regions may include recessed regions in the top substrate and/or the bottom substrate, particularly in which the recessed regions include a shape selected from the group consisting of circular, ovular, and polygonal.

In another embodiment, the increased gap-height regions are configured to facilitate droplet splitting. The one or more droplet transport paths may include one or more droplet operations electrodes configured to split the droplet between the increased gap-height regions. The increased gap-height regions may be adjacent to one or more reduced gap-height regions. The one or more reduced gap-height regions may also include a feature projecting from the top substrate and/or the bottom substrate, particularly in which the feature includes a shape selected from the group consisting of pointed, circular, ovular, and polygonal. A reduced gap-height region may be arranged between two increased gap-height regions, particularly in which the reduced gap-height region and the two increased gap-height regions substantially correspond to three droplet operations electrodes. The reduced gap-height region may be smaller than each of the two increased gap-height regions.

In another embodiment, the one or more droplet transport paths include one or more droplet operations electrodes configured to merge two droplets. The local variation in gap height may include a plurality of reduced gap-height regions along the one or more droplet transport paths. The reduced gap-height regions may be configured to facilitate droplet merging. The reduced gap-height regions may include a feature projecting from the top substrate and/or the bottom substrate, particularly in which the feature includes a shape selected from the group consisting of pointed, circular, ovular, and polygonal. The reduced gap-height regions may be adjacent to an increased gap-height region. The increased gap-height region may be arranged between two reduced gap-height regions, particularly in which the reduced gap-height regions are each smaller than the increased gap-height region.

In another embodiment, the invention provides a method for splitting a droplet, the method including use of a droplet actuator in which the configuration of reduced gap-height and increased gap-height regions is used to facilitate droplet splitting. In particular, a reduced gap-height region and two increased gap-height regions substantially correspond to three droplet operations electrodes on the droplet actuator and the method includes: a) elongating the droplet across the three droplet operations electrodes by activating the three droplet operations electrodes; and b) deactivating the droplet operations electrode substantially corresponding to the reduced gap-height region; in which the droplet is split into two droplets retained in the two increased gap-height regions. The droplet may include a volume of 3×, and the two droplets may each include a volume of 1.5×.

In another embodiment, the invention provides a method for merging droplets, the method including use of a droplet actuator in which the configuration of reduced gap-height and increased gap-height regions is used to facilitate droplet merging. In particular, the method includes: a) transporting two droplets toward a droplet merge region along separate droplet transport paths in a droplet transport region using droplet operations along droplet operations electrodes, in which the droplet merge region includes the increased gap-height region and in which the droplet transport region includes the two reduced gap-height regions; and b) activating one or more droplet operations electrodes in the increased gap-height region and deactivating droplet operations electrodes in the two reduced gap-height regions; in which the two droplets are merged into one droplet in the increased gap-height region. The two droplets may each include a volume of 1× and the one droplet may include a volume of 2×. The increased gap-height region may span one or more droplet operations electrodes, particularly three droplet operations electrodes.

In another embodiment, the invention provides a microfluidics system programmed to execute any of the methods described herein for droplet splitting and/or droplet merging. The invention also provides a storage medium including program code embodied in the medium for executing any of the methods described herein for droplet splitting and/or droplet merging.

### 5 BRIEF DESCRIPTION OF THE DRAWINGS

FIGS. 1A and 1B illustrate cross-sectional views of a portion of a droplet actuator that includes local variations in gap height for assisting droplet splitting operations, and a process of splitting a droplet;

FIGS. 2A, 2B, and 2C illustrate cross-sectional views of another portion of the droplet actuator that includes local variations in gap height for assisting droplet merge operations, and a process of merging two droplets;

FIGS. 3A and 3B illustrate plan views of an example of a bottom substrate and a top substrate, respectively, that includes the gap-height features shown in FIGS. 1A, 1B, 2A, 2B, and 2C;

FIG. 4 illustrates a plan view of the bottom substrate of FIG. 3A and the top substrate of FIG. 3B assembled together to form the droplet actuator;

FIGS. 5A and 5B illustrate cross-sectional views of another example of local variations in gap height for assisting droplet merge operations, and a process of merging two droplets;

FIGS. 6A, 6B, 7A, and 7B illustrate cross-sectional views of the droplet actuator showing other examples of implementing local variations in gap height for assisting droplet splitting operations; and

FIG. 8 illustrates a functional block diagram of an example of a microfluidics system that includes a droplet actuator.

### 6 DEFINITIONS

As used herein, the following terms have the meanings indicated.

“Activate,” with reference to one or more electrodes, means affecting a change in the electrical state of the one or more electrodes which, in the presence of a droplet, results in a droplet operation. Activation of an electrode can be accomplished using alternating or direct current. Any suitable voltage may be used. For example, an electrode may be activated using a voltage which is greater than about 150 V, or greater than about 200 V, or greater than about 250 V, or from about 275 V to about 1000 V, or about 300 V. Where alternating current is used, any suitable frequency may be employed. For example, an electrode may be activated using alternating current having a frequency from about 1 Hz to about 10 MHz, or from about 10 Hz to about 60 Hz, or from about 20 Hz to about 40 Hz, or about 30 Hz.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical, amorphous and other three dimensional shapes. The bead may, for example, be capable of being subjected to a droplet operation in a droplet on a droplet actuator or otherwise configured with respect to a droplet actuator in a manner which permits a droplet on the droplet actuator to be brought into contact with the bead on the droplet actuator and/or off the droplet actuator. Beads may be provided in a droplet, in a droplet operations gap, or on a droplet operations surface. Beads may be provided in a reservoir that is external to a droplet operations gap or situated apart from a droplet operations surface, and the reservoir may be associated with a flow path that permits a droplet including the beads to be brought into a droplet operations gap or into contact with a droplet operations surface. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead, a portion of a bead, or only one component of a bead. The remainder of the bead may include, among other things, polymeric material, coatings, and moieties which permit attachment of an assay reagent. Examples of suitable beads include flow cytometry microbeads, polystyrene microparticles and nanoparticles, functionalized polystyrene microparticles and nanoparticles, coated polystyrene microparticles and nanoparticles, silica microbeads, fluorescent microspheres and nanospheres, functionalized fluorescent microspheres and nanospheres, coated fluorescent microspheres and nanospheres, color dyed microparticles and nanoparticles, magnetic microparticles and nanoparticles, superparamagnetic microparticles and nanoparticles (e.g., DYNABEADS® particles, available from Invitrogen Group, Carlsbad, Calif.), fluorescent microparticles and nanoparticles, coated magnetic microparticles and nanoparticles, ferromagnetic microparticles and nanoparticles, coated ferromagnetic microparticles and nanoparticles, and those described in U.S. Patent Publication Nos. 20050260686, entitled “Multiplex flow assays preferably with magnetic particles as solid phase,” published on Nov. 24, 2005; 20030132538, entitled “Encapsulation of discrete quanta of fluorescent particles,” published on Jul. 17, 2003; 20050118574, entitled “Multiplexed Analysis of Clinical Specimens Apparatus and Method,” published on Jun. 2, 2005; 20050277197. Entitled “Microparticles with Multiple Fluorescent Signals and Methods of Using Same,” published on Dec. 15, 2005; 20060159962, entitled “Magnetic Microspheres for use in Fluorescence-based Applications,” published on Jul. 20, 2006; the entire disclosures of which are incorporated herein by reference for their teaching concerning beads and magnetically responsive materials and beads. Beads may be pre-coupled with a biomolecule or other substance that is able to bind to and form a complex with a biomolecule. Beads may be pre-coupled with an antibody, protein or antigen, DNA/RNA probe or any other molecule with an affinity for a desired target. Examples of droplet actuator techniques for immobilizing magnetically responsive beads and/or non-magnetically responsive beads and/or conducting droplet operations protocols using beads are described in U.S. patent application Ser. No. 11/639,566, entitled “Droplet-Based Particle Sorting,” filed on Dec. 15, 2006; U.S. Patent Application No. 61/039,183, entitled “Multiplexing Bead Detection in a Single Droplet,” filed on Mar. 25, 2008; U.S. Patent Application No. 61/047,789, entitled “Droplet Actuator Devices and Droplet Operations Using Beads,” filed on Apr. 25, 2008; U.S. Patent Application No. 61/086,183, entitled “Droplet Actuator Devices and Methods for Manipulating Beads,” filed on Aug. 5, 2008; International Patent Application No. PCT/US2008/053545, entitled “Droplet Actuator Devices and Methods Employing Magnetic Beads,” filed on Feb. 11, 2008; International Patent Application No. PCT/US2008/058018, entitled “Bead-based Multiplexed Analytical Methods and Instrumentation,” filed on Mar. 24, 2008; International Patent Application No. PCT/US2008/058047, “Bead Sorting on a Droplet Actuator,” filed on Mar. 23, 2008; and International Patent Application No. PCT/US2006/047486, entitled “Droplet-based Biochemistry,” filed on Dec. 11, 2006; the entire disclosures of which are incorporated herein by reference. Bead characteristics may be employed in the multiplexing aspects of the invention. Examples of beads having characteristics suitable for multiplexing, as well as methods of detecting and analyzing signals emitted from such beads, may be found in U.S. Patent Publication No. 20080305481, entitled “Systems and Methods for Multiplex Analysis of PCR in Real Time,” published on Dec. 11, 2008; U.S. Patent Publication No. 20080151240, “Methods and Systems for Dynamic Range Expansion,” published on Jun. 26, 2008; U.S. Patent Publication No. 20070207513, entitled “Methods, Products, and Kits for Identifying an Analyte in a Sample,” published on Sep. 6, 2007; U.S. Patent Publication No. 20070064990, entitled “Methods and Systems for Image Data Processing,” published on Mar. 22, 2007; U.S. Patent Publication No. 20060159962, entitled “Magnetic Microspheres for use in Fluorescence-based Applications,” published on Jul. 20, 2006; U.S. Patent Publication No. 20050277197, entitled “Microparticles with Multiple Fluorescent Signals and Methods of Using Same,” published on Dec. 15, 2005; and U.S. Patent Publication No. 20050118574, entitled “Multiplexed Analysis of Clinical Specimens Apparatus and Method,” published on Jun. 2, 2005.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids. A droplet may include one or more beads.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. No. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a droplet operations gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, N.J.) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define dispensing reservoirs. The spacer height may, for example, be from about 5 μm to about 600 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a flow path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), other fluorinated monomers for plasma-enhanced chemical vapor deposition (PECVD), and organosiloxane (e.g., SiOC) for PECVD. In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose Calif.); ARLON™ 11N (available from Arlon, Inc, Santa Ana, Calif.).; NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper. Various materials are also suitable for use as the dielectric component of the substrate. Examples include: vapor deposited dielectric, such as PARYLENE™ C (especially on glass), PARYLENE™ N, and PARYLENE™ HT (for high temperature, ˜300° C.) (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; polypropylene; and black flexible circuit materials, such as DuPont™ Pyralux® HXC and DuPont™ Kapton® MBC (available from DuPont, Wilmington, Del.). Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, inter-electrode pitch, and gap height (between top and bottom substrates) may be varied for use with specific reagents, protocols, droplet volumes, etc. In some cases, a substrate of the invention may derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, other fluorinated monomers for plasma-enhanced chemical vapor deposition (PECVD), and organosiloxane (e.g., SiOC) for PECVD. Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance or capacitance sensing or imaging techniques may sometimes be used to determine or confirm the outcome of a droplet operation. Examples of such techniques are described in Sturmer et al., U.S. Patent Application Publication No. US20100194408, entitled “Capacitance Detection in a Droplet Actuator,” published on Aug. 5, 2010, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may exceed about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to electrowetting area; in other words, 1×-, 2×-3×-droplets are usefully controlled operated using 1, 2, and 3 electrodes, respectively. If the droplet footprint is greater than the number of electrodes available for conducting a droplet operation at a given time, the difference between the droplet size and the number of electrodes should typically not be greater than 1; in other words, a 2× droplet is usefully controlled using 1 electrode and a 3× droplet is usefully controlled using 2 electrodes. When droplets include beads, it is useful for droplet size to be equal to the number of electrodes controlling the droplet, e.g., transporting the droplet.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator is typically filled with a filler fluid. The filler fluid may, for example, be a low-viscosity oil, such as silicone oil or hexadecane filler fluid. The filler fluid may fill the entire gap of the droplet actuator or may coat one or more surfaces of the droplet actuator. Filler fluids may be conductive or non-conductive. Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan et al, International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein.

“Immobilize” with respect to magnetically responsive beads, means that the beads are substantially restrained in position in a droplet or in filler fluid on a droplet actuator. For example, in one embodiment, immobilized beads are sufficiently restrained in position in a droplet to permit execution of a droplet splitting operation, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe3O4, BaFe12O19, CoO, NiO, Mn2O3, Cr2O3, and CoMnP.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

“Transporting into the magnetic field of a magnet,” “transporting towards a magnet,” and the like, as used herein to refer to droplets and/or magnetically responsive beads within droplets, is intended to refer to transporting into a region of a magnetic field capable of substantially attracting magnetically responsive beads in the droplet. Similarly, “transporting away from a magnet or magnetic field,” “transporting out of the magnetic field of a magnet,” and the like, as used herein to refer to droplets and/or magnetically responsive beads within droplets, is intended to refer to transporting away from a region of a magnetic field capable of substantially attracting magnetically responsive beads in the droplet, whether or not the droplet or magnetically responsive beads is completely removed from the magnetic field. It will be appreciated that in any of such cases described herein, the droplet may be transported towards or away from the desired region of the magnetic field, and/or the desired region of the magnetic field may be moved towards or away from the droplet. Reference to an electrode, a droplet, or magnetically responsive beads being “within” or “in” a magnetic field, or the like, is intended to describe a situation in which the electrode is situated in a manner which permits the electrode to transport a droplet into and/or away from a desired region of a magnetic field, or the droplet or magnetically responsive beads is/are situated in a desired region of the magnetic field, in each case where the magnetic field in the desired region is capable of substantially attracting any magnetically responsive beads in the droplet. Similarly, reference to an electrode, a droplet, or magnetically responsive beads being “outside of” or “away from” a magnetic field, and the like, is intended to describe a situation in which the electrode is situated in a manner which permits the electrode to transport a droplet away from a certain region of a magnetic field, or the droplet or magnetically responsive beads is/are situated away from a certain region of the magnetic field, in each case where the magnetic field in such region is not capable of substantially attracting any magnetically responsive beads in the droplet or in which any remaining attraction does not eliminate the effectiveness of droplet operations conducted in the region. In various aspects of the invention, a system, a droplet actuator, or another component of a system may include a magnet, such as one or more permanent magnets (e.g., a single cylindrical or bar magnet or an array of such magnets, such as a Halbach array) or an electromagnet or array of electromagnets, to form a magnetic field for interacting with magnetically responsive beads or other components on chip. Such interactions may, for example, include substantially immobilizing or restraining movement or flow of magnetically responsive beads during storage or in a droplet during a droplet operation or pulling magnetically responsive beads out of a droplet.

“Washing” with respect to washing a bead means reducing the amount and/or concentration of one or more substances in contact with the bead or exposed to the bead from a droplet in contact with the bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Examples of suitable washing techniques are described in Pamula et al., U.S. Pat. No. 7,439,014, entitled “Droplet-Based Surface Modification and Washing,” granted on Oct. 21, 2008, the entire disclosure of which is incorporated herein by reference.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface. In one example, filler fluid can be considered as a film between such liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### 7 DESCRIPTION

The invention is directed to a droplet actuator with local variation in gap height to assist in droplet splitting and merging operations. In one example, the droplet actuator has increased gap-height regions that track droplet transport paths. The increase in gap height can be a recessed region in the top substrate, the bottom substrate, or both. Droplets can be transported along the paths with reduced risk of merging with droplets on adjacent paths.

In another example, the droplet actuator has increased gap-height regions that facilitate droplet splitting. The increase in gap height can be a recessed region in the top substrate, the bottom substrate, or both. They can be any shape, e.g., circular, ovular, polygonal, etc. Droplets can be split by activating electrodes to cause the droplet to elongate across the region of the increased gap height then deactivating a droplet operations electrode between the regions of increased gap height. The regions of increased gap height may have different sizes, e.g., a very large region which is used to dispense droplets to a smaller region.

In yet another example, the droplet actuator has reduced gap-height regions that facilitate droplet splitting. The reduction in gap height can be a feature projecting from the top substrate, the bottom substrate, or both. Droplets can be split by activating electrodes to cause the droplet to elongate across the region of the reduction in gap height then deactivating a droplet operations electrode in the region of the reduction in gap height.

In another example, the droplet actuator has regions of increased hydrophobicity that facilitate droplet splitting. The regions of increased hydrophobicity can be provided by a superhydrophobic coating or hydrophobic patterning on the bottom substrate and/or the top substrate. Droplets can be split by activating electrodes adjacent to the region of increased hydrophobicity, thereby causing the droplet to elongate across the region of increased hydrophobicity. Liquid naturally flows from regions of higher hydrophobicity to regions of lower hydrophobicity, and therefore droplets that elongate across the region of increased hydrophobicity will split into two droplets.

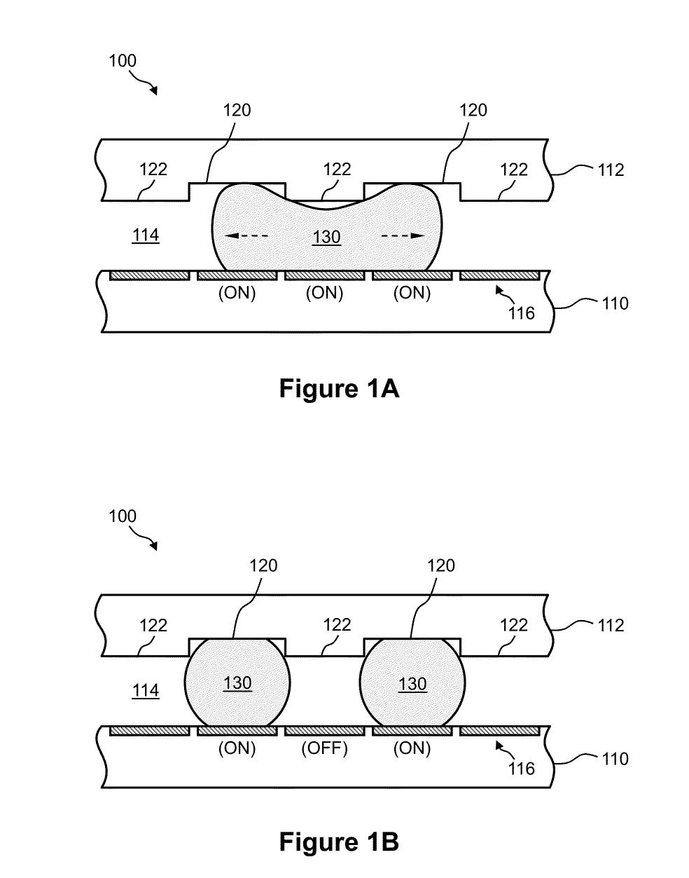

FIGS. 1A and 1B illustrate cross-sectional views of a portion of a droplet actuator 100 that includes local variations in gap height for assisting droplet splitting operations, and a process of splitting a droplet. Droplet actuator 100 includes a bottom substrate 110 and a top substrate 112 that are separated by a droplet operations gap 114. Bottom substrate 110 may include an arrangement of droplet operations electrodes 116 (e.g., electrowetting electrodes). Droplet operations are conducted atop droplet operations electrodes 116 on a droplet operations surface.

Droplet actuator 100 is a droplet actuator with increased gap-height regions that facilitate droplet splitting. The increase in gap height can be, for example, a recessed region in bottom substrate 110, top substrate 112, or both. In the example shown in FIGS. 1A and 1B, top substrate 112 includes recessed regions to form increased gap-height regions 120. Increased gap-height regions 120 can be any recessed regions, channels, grooves, or detents, which can be formed, for example, by etching the surface of top substrate 112 or by injection molding.

In top substrate 112, the regions outside of these recessed regions (i.e., outside of increased gap-height regions 120) are reduced gap-height regions 122. More specifically, in this example, a reduced gap-height region 122 is arranged between two increased gap-height regions 120. Further, the positions of the reduced gap-height region 122 and the two increased gap-height regions 120 substantially correspond to three droplet operations electrodes 116.

In this example, the reduced gap-height region 122 provides a feature between the two increased gap-height regions 120 that can be used as a droplet splitting mechanism. For example, FIG. 1A shows a slug of liquid 118 elongated across the three droplet operations electrodes 116 that correspond to the reduced gap-height region 122 and the two increased gap-height regions 120. This is because all three droplet operations electrodes 116 are activated (i.e., turned on). Liquid 118 is, for example, sample fluid or liquid reagent. Referring now to FIG. 1B, when the droplet operations electrode 116 at reduced gap-height region 122 is deactivated (i.e., turned off) the slug of liquid 118 is split into two droplets 118. Further, the two increased gap-height regions 120 can accommodate larger volume droplets than can the reduced gap-height region 122. In one example, the volume of the 3× slug of liquid 118 can be split into two 1.5× droplets 118, which can be retained in the two increased gap-height regions 120.

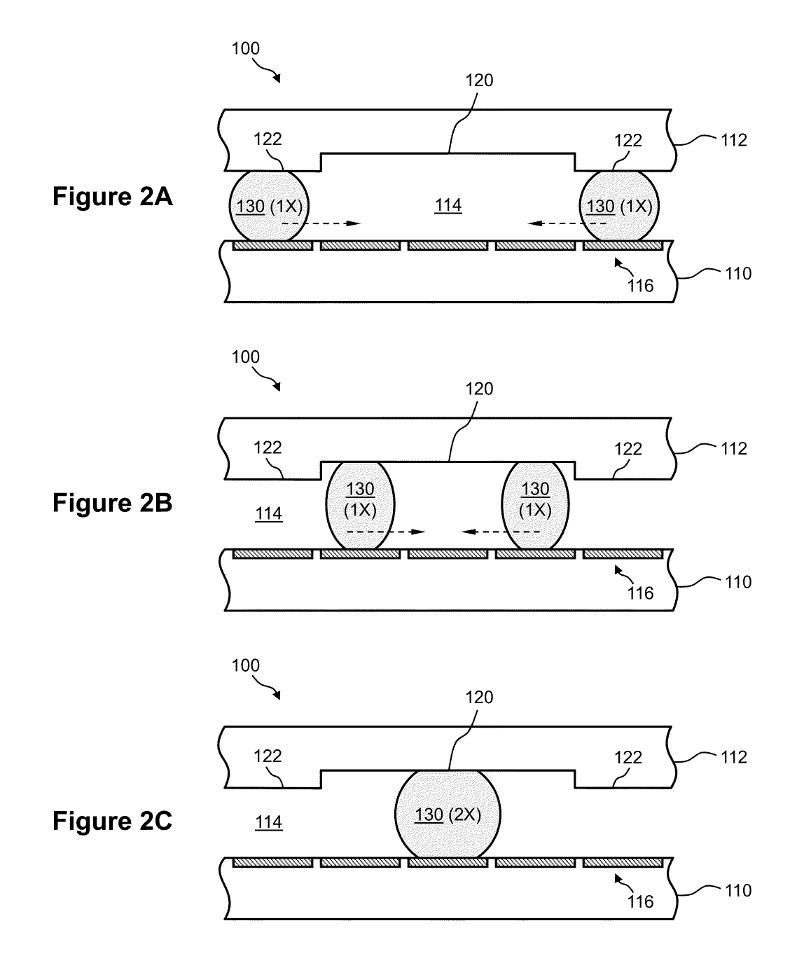

Due to the larger gap size, the pressure in the two increased gap-height regions 120 is lower than the pressure in the reduced gap-height region 122. Liquid naturally flows from a high-pressure region to a low-pressure region. Therefore, liquid 118 tends to flow from the reduced gap-height region 122 and into the two increased gap-height regions 120. Additionally, once the two droplets 118 are formed in the two increased gap-height regions 120, the reduced gap-height region 122 acts to pin the two droplets 118 within the two increased gap-height regions 120. Further, the increased gap-height regions 120 may have different sizes, e.g., a very large region which is used to dispense droplets to a smaller region.

Whereas FIGS. 1A and 1B show only a portion of droplet actuator 100, this portion, which includes the arrangement of a reduced gap-height region 122 between two increased gap-height regions 120, can be considered a droplet splitting region of droplet actuator 100. By contrast, an example of a droplet merge region of droplet actuator 100 are shown and described with reference to FIGS. 2A, 2B, and 2C.

FIGS. 2A, 2B, and 2C illustrate cross-sectional views of another portion of droplet actuator 100 that includes local variations in gap height for assisting droplet merge operations, and a process of merging two droplets. More specifically, FIGS. 2A, 2B, and 2C show another arrangement of increased gap-height regions 120 and reduced gap-height regions 122 that form a droplet merge region within droplet actuator 100. Namely, an increased gap-height region 120 spans, for example, three droplet operations electrodes 116. In this example, two 1× droplets 118 that originate from within reduced gap-height regions 122 can be merged into one 2× droplet 118 in the increased gap-height region 120.

For example, FIG. 2A shows two 1× droplets 118 (one 1× droplet 118 on either side of increased gap-height region 120) are transported by droplet operations along droplet operations electrodes 116 toward each other and toward increased gap-height region 120. FIG. 2B shows the two 1× droplets 118 moving toward each other within the increased gap-height region 120. FIG. 2C shows the two 1× droplets 118 merged into one 2× droplet 118 atop one droplet operations electrode 116 within increased gap-height region 120. Because of the larger gap size, increased gap-height region 120 is able to accommodate the volume of the 2× droplet 118 atop one unit-sized droplet operations electrode 116.

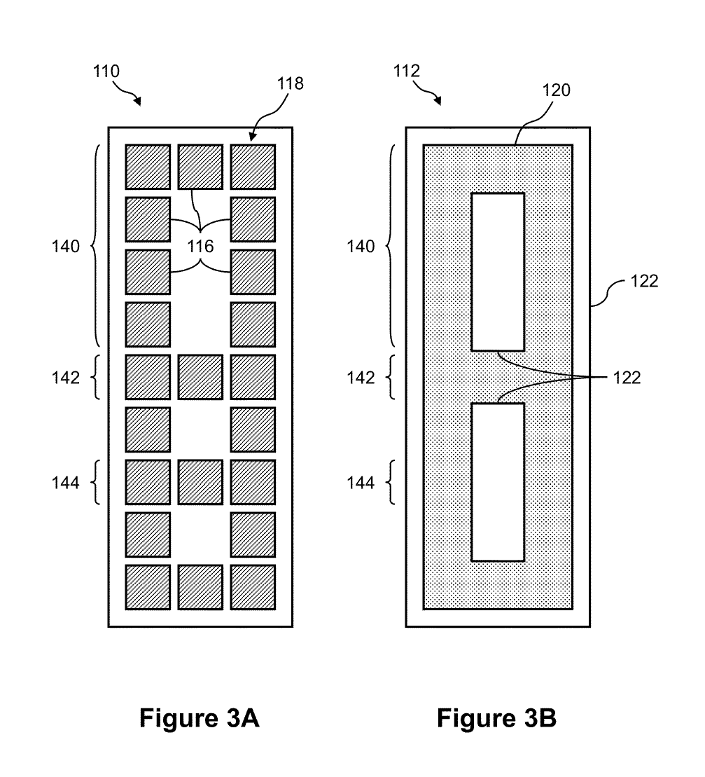

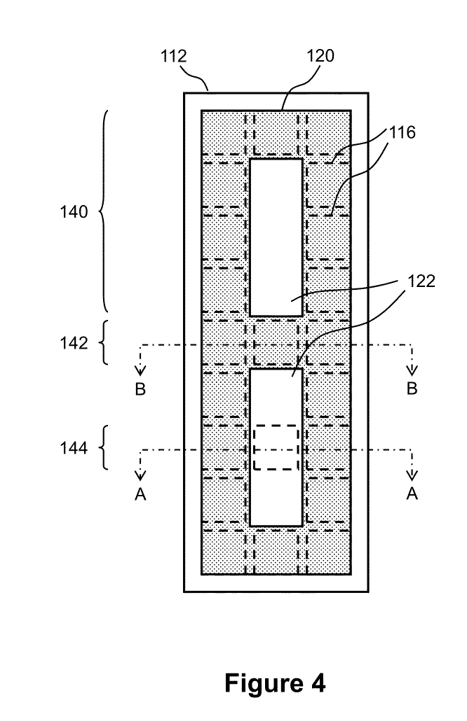

FIGS. 3A and 3B illustrate plan views of an example of bottom substrate 110 and top substrate 112, respectively, of droplet actuator 100, which include the gap-height features shown in FIGS. 1A, 1B, 2A, 2B, and 2C. For example, FIG. 3A shows an example of bottom substrate 110 that includes an electrode arrangement 118 of the droplet operations electrodes 116, while FIG. 3B shows an example of top substrate 112 that includes an arrangement of an increased gap-height region 120 and reduced gap-height regions 122, as shown. Bottom substrate 110 and top substrate 112 are designed to support a droplet transport region 140, a droplet merge region 142, and a droplet splitting region 144. In this example, increased gap-height region 120 tracks with certain droplet transport paths. More details of bottom substrate 110 and top substrate 112 when assembled are shown and described with reference to FIG. 4.

FIG. 4 illustrates a plan view of bottom substrate 110 of FIG. 3A and top substrate 112 of FIG. 3B assembled together to form droplet actuator 100. Namely, top substrate 112 is shown atop bottom substrate 110, again showing droplet transport region 140, droplet merge region 142, and droplet splitting region 144. FIG. 4 also shows that increased gap-height region 120 tracks with certain droplet transport paths (i.e., certain lines of droplet operations electrodes 116). For example, because increased gap-height region 120 tracks with droplet operations electrodes 116 in droplet transport region 140, droplets can be transported along these paths with reduced risk of merging with other droplets on adjacent paths.

The view of droplet actuator 100 shown in FIGS. 1A and 1B is an example of the droplet splitting region 144 of FIG. 4; namely, the cross-sectional views in FIGS. 1A and 1B are taken along line AA of FIG. 4. Accordingly, the droplet splitting operations described with reference to FIGS. 1A and 1B can take place in droplet splitting region 144. Further, the view of droplet actuator 100 shown of FIGS. 2A, 2B, and 2C is an example of the droplet merge region 142 of FIG. 4; namely, the cross-sectional views of FIGS. 2A, 2B, and 2C are taken along line BB of FIG. 4. Accordingly, the droplet merge operations described with reference to FIGS. 2A, 2B, and 2C can take place in droplet merge region 142.

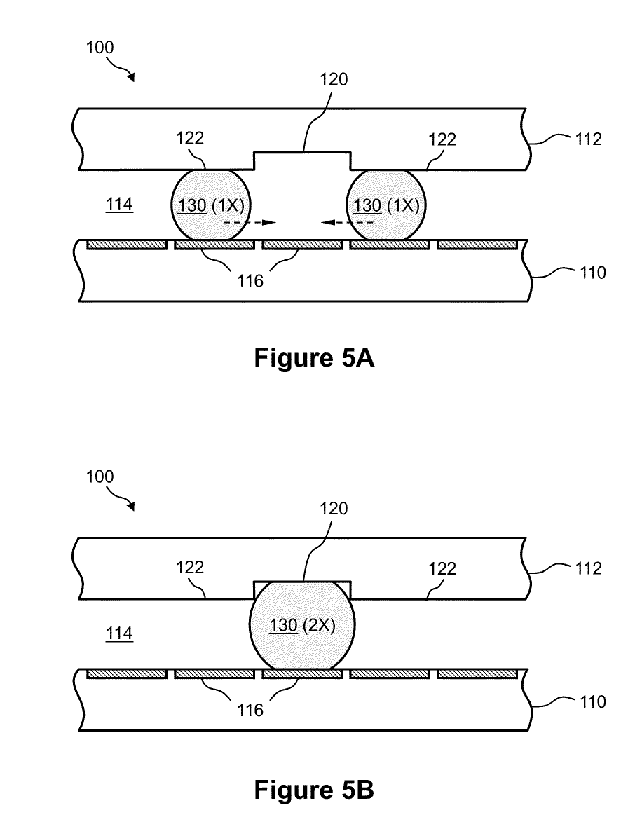

FIGS. 5A and 5B illustrate cross-sectional views of another example of local variations in gap height for assisting droplet merge operations, and a process of merging two droplets. Namely, FIGS. 5A and 5B show another example of droplet merge region 142 of FIG. 4. In this example, increased gap-height region 120 spans only one droplet operations electrode 116.

For example, FIG. 5A shows two 1× droplets 118 (one 1× droplet 118 on either side of increased gap-height region 120) are transported by droplet operations along droplet operations electrodes 116 toward each other and toward increased gap-height region 120. FIG. 5B shows the two 1× droplets 118 merged into one 2× droplet 118 atop one droplet operations electrode 116 within increased gap-height region 120. Because of the larger gap size, increased gap-height region 120 is able to accommodate the volume of the 2× droplet 118 atop one unit-sized droplet operations electrode 116.

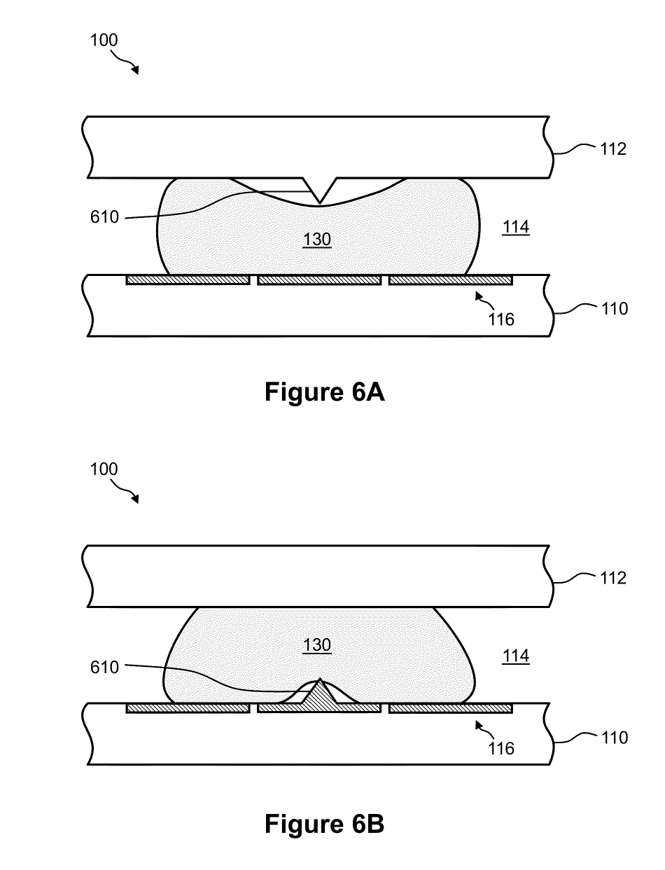

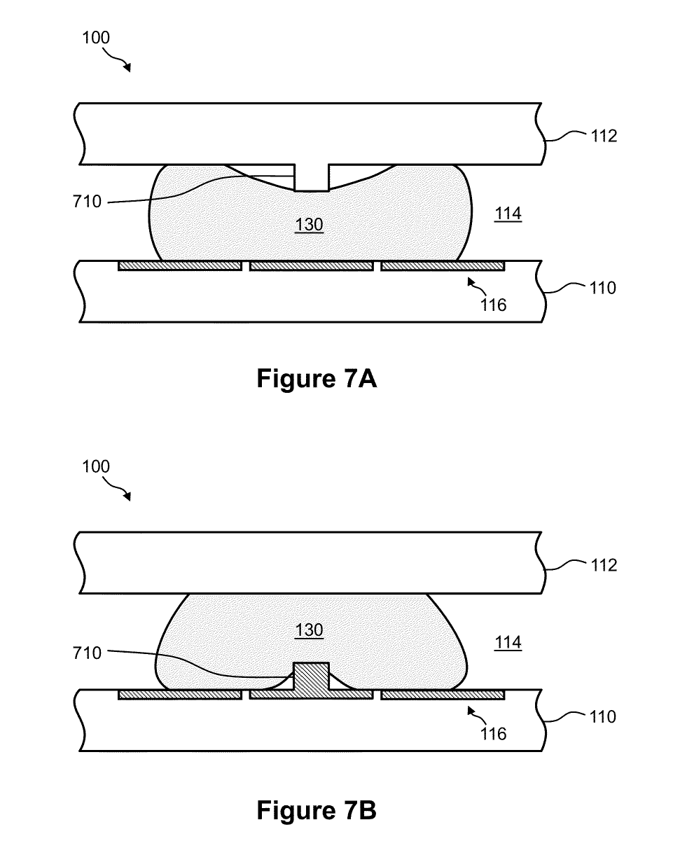

FIGS. 6A, 6B, 7A, and 7B illustrate cross-sectional views of the droplet actuator showing other examples of implementing local variations in gap height for assisting droplet splitting operations. For example, certain gap-height features can be implemented in top substrate 112 and/or bottom substrate 110. Further, the gap-height features can be any shape, such as, but not limited to, pointed, circular, ovular, polygonal, and the like.

In one example, FIG. 6A shows a pointed gap-height feature 610 projecting from top substrate 112 and into droplet operations gap 114. The tip of the pointed gap-height feature 610 provides a reduced gap-height region within droplet actuator 100 that can be used to facilitate droplet splitting operations. FIG. 6B shows the pointed gap-height feature 610 projecting from bottom substrate 110 instead of from top substrate 112.

In another example, FIG. 7B shows a square- or rectangular-shaped gap-height feature 710 projecting from top substrate 112 and into droplet operations gap 114. The tip of the square- or rectangular-shaped gap-height feature 710 provides a reduced gap-height region within droplet actuator 100 that can be used to facilitate droplet splitting operations. FIG. 7B shows the square- or rectangular-shaped gap-height feature 710 projecting from bottom substrate 110 instead of from top substrate 112.

In summary and referring again to FIGS. 6A, 6B, 7A, and 7B, the gap-height features 610 and 710 provide reduced gap-height regions within droplet actuator 100 that can facilitate droplet splitting operations. The reduction in gap height can be gap-height feature 610 or 710 projecting from top substrate 112, projecting from bottom substrate 110, or projecting from both. Droplets can be split by activating droplet operations electrodes 116 to cause the droplet to elongate across the region of the reduction in gap height then deactivating a droplet operations electrode 116 in the region of the reduction in gap height.

### 7.1 Systems

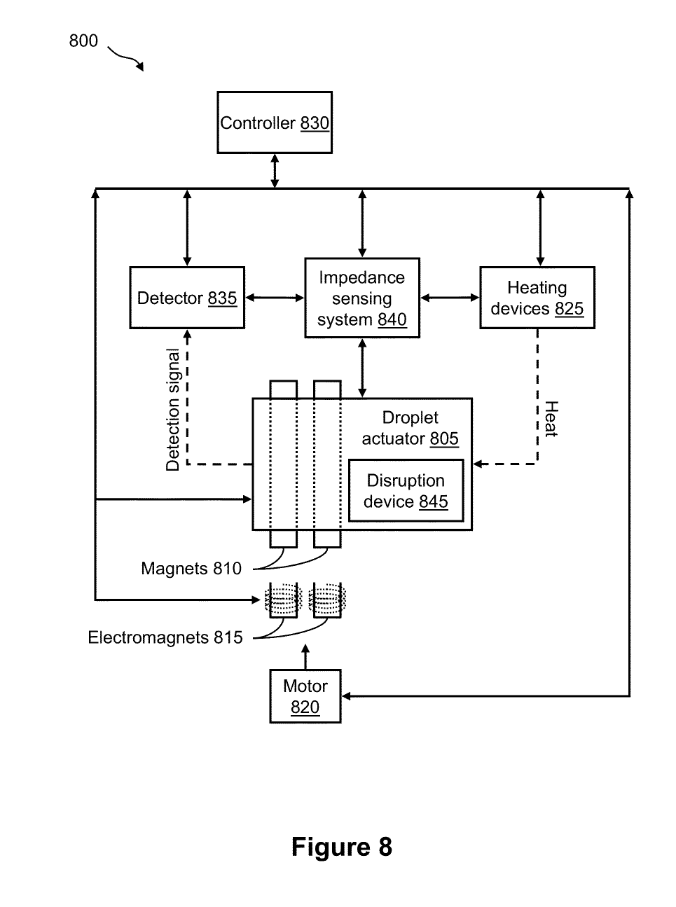

FIG. 8 illustrates a functional block diagram of an example of a microfluidics system 800 that includes a droplet actuator 805. Digital microfluidic technology conducts droplet operations on discrete droplets in a droplet actuator, such as droplet actuator 805, by electrical control of their surface tension (electrowetting). The droplets may be sandwiched between two substrates of droplet actuator 805, a bottom substrate and a top substrate separated by a droplet operations gap. The bottom substrate may include an arrangement of electrically addressable electrodes. The top substrate may include a reference electrode plane made, for example, from conductive ink or indium tin oxide (ITO). The bottom substrate and the top substrate may be coated with a hydrophobic material. Droplet operations are conducted in the droplet operations gap. The space around the droplets (i.e., the gap between bottom and top substrates) may be filled with an immiscible inert fluid, such as silicone oil, to prevent evaporation of the droplets and to facilitate their transport within the device. Other droplet operations may be effected by varying the patterns of voltage activation; examples include merging, splitting, mixing, and dispensing of droplets.

Droplet actuator 805 may be designed to fit onto an instrument deck (not shown) of microfluidics system 800. The instrument deck may hold droplet actuator 805 and house other droplet actuator features, such as, but not limited to, one or more magnets and one or more heating devices. For example, the instrument deck may house one or more magnets 810, which may be permanent magnets. Optionally, the instrument deck may house one or more electromagnets 815. Magnets 810 and/or electromagnets 815 are positioned in relation to droplet actuator 805 for immobilization of magnetically responsive beads. Optionally, the positions of magnets 810 and/or electromagnets 815 may be controlled by a motor 820. Additionally, the instrument deck may house one or more heating devices 825 for controlling the temperature within, for example, certain reaction and/or washing zones of droplet actuator 805. In one example, heating devices 825 may be heater bars that are positioned in relation to droplet actuator 805 for providing thermal control thereof.

A controller 830 of microfluidics system 800 is electrically coupled to various hardware components of the invention, such as droplet actuator 805, electromagnets 815, motor 820, and heating devices 825, as well as to a detector 835, an impedance sensing system 840, and any other input and/or output devices (not shown). Controller 830 controls the overall operation of microfluidics system 800. Controller 830 may, for example, be a general purpose computer, special purpose computer, personal computer, or other programmable data processing apparatus. Controller 830 serves to provide processing capabilities, such as storing, interpreting, and/or executing software instructions, as well as controlling the overall operation of the system. Controller 830 may be configured and programmed to control data and/or power aspects of these devices. For example, in one aspect, with respect to droplet actuator 805, controller 830 controls droplet manipulation by activating/deactivating electrodes.

In one example, detector 835 may be an imaging system that is positioned in relation to droplet actuator 805. In one example, the imaging system may include one or more light-emitting diodes (LEDs) (i.e., an illumination source) and a digital image capture device, such as a charge-coupled device (CCD) camera.

Impedance sensing system 840 may be any circuitry for detecting impedance at a specific electrode of droplet actuator 805. In one example, impedance sensing system 840 may be an impedance spectrometer. Impedance sensing system 840 may be used to monitor the capacitive loading of any electrode, such as any droplet operations electrode, with or without a droplet thereon. For examples of suitable capacitance detection techniques, see Sturmer et al., International Patent Publication No. WO/2008/101194, entitled “Capacitance Detection in a Droplet Actuator,” published on Aug. 21, 2008; and Kale et al., International Patent Publication No. WO/2002/080822, entitled “System and Method for Dispensing Liquids,” published on Oct. 17, 2002; the entire disclosures of which are incorporated herein by reference.

Droplet actuator 805 may include disruption device 845. Disruption device 845 may include any device that promotes disruption (lysis) of materials, such as tissues, cells and spores in a droplet actuator. Disruption device 845 may, for example, be a sonication mechanism, a heating mechanism, a mechanical shearing mechanism, a bead beating mechanism, physical features incorporated into the droplet actuator 805, an electric field generating mechanism, a thermal cycling mechanism, and any combinations thereof. Disruption device 845 may be controlled by controller 830.

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

### 8 CONCLUDING REMARKS

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicants' invention set forth in this specification, and neither its use nor its absence is intended to limit the scope of the applicants' invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

We claim:

1. A droplet actuator comprising a bottom substrate and a top substrate, in which the bottom substrate and the top substrate are separated by a droplet operations gap comprising a droplet, wherein the droplet operations gap comprises local variation in gap height configured to assist in droplet splitting and/or droplet merging operations.

2. The droplet actuator of claim 1, wherein the top substrate and/or the bottom substrate comprises a droplet transport region and a droplet merge region and/or a droplet splitting region.

3. The droplet actuator of claim 2, wherein the top substrate and/or the bottom substrate comprises one or more droplet transport paths.

4. The droplet actuator of claim 3, wherein the local variation in gap height comprises a plurality of increased gap-height regions along the one or more droplet transport paths.

5. The droplet actuator of claim 4, wherein the plurality of increased gap-height regions comprises recessed regions in the top substrate and/or the bottom substrate.

6. The droplet actuator of claim 5, wherein the recessed regions comprise a shape selected from the group consisting of circular, ovular, and polygonal.

7. The droplet actuator of claim 5, wherein the increased gap-height regions are configured to facilitate droplet splitting.

8. The droplet actuator of claim 7, wherein the one or more droplet transport paths comprise one or more droplet operations electrodes configured to split the droplet between the increased gap-height regions.

9. The droplet actuator of claim 8, wherein the increased gap-height regions are adjacent to one or more reduced gap-height regions.

10. The droplet actuator of claim 9, wherein the one or more reduced gap-height regions comprise a feature projecting from the top substrate and/or the bottom substrate.

11. The droplet actuator of claim 10, wherein the feature comprises a shape selected from the group consisting of pointed, circular, ovular, and polygonal.

12. The droplet actuator of claim 10, comprising a reduced gap-height region arranged between two increased gap-height regions.

13. The droplet actuator of claim 12, wherein the reduced gap-height region and the two increased gap-height regions substantially correspond to three droplet operations electrodes.

14. The droplet actuator of claim 12, wherein the reduced gap-height region is smaller than each of the two increased gap-height regions.

15. The droplet actuator of claim 3, wherein the one or more droplet transport paths comprise one or more droplet operations electrodes configured to merge two droplets.

16. The droplet actuator of claim 15, wherein the local variation in gap height comprises a plurality of reduced gap-height regions along the one or more droplet transport paths.

17. The droplet actuator of claim 16, wherein the reduced gap-height regions are configured to facilitate droplet merging.

18. The droplet actuator of claim 17, wherein the reduced gap-height regions comprise a feature projecting from the top substrate and/or the bottom substrate.

19. The droplet actuator of claim 18, wherein the feature comprises a shape selected from the group consisting of pointed, circular, ovular, and polygonal.

20. The droplet actuator of claim 19, wherein the reduced gap-height regions are adjacent to an increased gap-height region.

21. The droplet actuator of claim 20, comprising an increased gap-height region arranged between two reduced gap-height regions.

22. The droplet actuator of claim 21, wherein the reduced gap-height regions are each smaller than the increased gap-height region.

23. A method for splitting a droplet, the method comprising use of the droplet actuator of claim 9 wherein the configuration of reduced gap-height and increased gap-height regions is used to facilitate droplet splitting.

24. The method for splitting a droplet of claim 23, wherein the reduced gap-height region and the two increased gap-height regions substantially correspond to three droplet operations electrodes, the method comprising:
a. elongating the droplet across the three droplet operations electrodes by activating the three droplet operations electrodes; and
b. deactivating the droplet operations electrode substantially corresponding to the reduced gap-height region;
wherein the droplet is split into two droplets retained in the two increased gap-height regions.

25. The method of claim 24, wherein the droplet comprises a volume of 3×, and wherein the two droplets each comprise a volume of 1.5×.

26. A method for merging droplets, the method comprising use of the droplet actuator of claim 21 wherein the configuration of reduced gap-height and increased gap-height regions is used to facilitate droplet merging.

27. The method for merging droplets of claim 26, the method comprising:
a. transporting two droplets toward the droplet merge region along separate droplet transport paths in the droplet transport region using droplet operations along droplet operations electrodes, wherein the droplet merge region comprises the increased gap-height region and wherein the droplet transport region comprises the two reduced gap-height regions; and
b. activating one or more droplet operations electrodes in the increased gap-height region and deactivating droplet operations electrodes in the two reduced gap-height regions;
wherein the two droplets are merged into one droplet in the increased gap-height region.

28. The method of claim 27, wherein two droplets each comprise a volume of 1× and the one droplet comprises a volume of 2×.

29. The method of claim 28, wherein the increased gap-height region spans one or more droplet operations electrodes.

30. The method of claim 29, wherein the increased gap-height region spans three droplet operations electrodes.

31. A microfluidics system programmed to execute the method of claim 24 for droplet splitting.

32. A storage medium comprising program code embodied in the medium for executing the method of claim 24 for droplet splitting.

33. A microfluidics system programmed to execute the method of claim 27 for droplet merging.

34. A storage medium comprising program code embodied in the medium for executing the method of claim 27 for droplet merging.
